(19) United States
(12) Patent Application Publication
(10) Pub. No.: US 2020/0251105 A1
(43) Pub. Date: Aug. 6, 2020

(54) METHOD AND SYSTEM FOR PROVIDING CONVERSATION SERVICE BY USING AUTONOMOUS BEHAVIOR ROBOT, AND NON-TRANSITORY COMPUTER-READABLE RECORDING MEDIUM

(71) Applicant: TOROOC INC., Seoul (KR)

(72) Inventor: Jun Seok JUNG, Seoul (KR)

(73) Assignee: TOROOC INC., Seoul (KR)

(21) Appl. No.: 16/652,034

(22) PCT Filed: Sep. 29, 2017
(86) PCT No.: PCT/KR2017/011020

§ 371 Date: Mar. 28, 2020

(51) Int. Cl. G10L 15/22; G06K 9/00; B25J 11/00

(52) U.S. Cl. CPC G10L 15/22; G06K 9/00288; G10L 2015/225; B25J 11/0005; G06K 9/00302

(57) ABSTRACT

According to one aspect of the present invention, provided is a method for providing a conversation service by using an autonomous behavior robot, comprising the steps of: recognizing a user corresponding to acquired face information; determining conversation content to be provided to the user on the basis of a personal attribute related to the recognized user and/or the reliability of the personal attribute; and updating the personal attribute and/or the reliability of the personal attribute on the basis of the user's feedback for the conversation content.

### TECHNICAL FIELD

The present invention relates to a method, system and non-transitory computer readable recording medium for providing a conversation service using an autonomous behavior robot.

### BACKGROUND ART

In recent years, with the development of artificial intelligence and robot technology, many researches have been conducted on autonomous robots that can naturally communicate with humans and operate by making decisions by themselves.

In this regard, as one example of the related art, there have been introduced a robot that generates a conversation based on voice of a user and receives and outputs a content conversation generated based on the conversation, and a conversation service apparatus that converts a conversation input from a robot into a content sentence, and transmits the content conversation including the converted content sentence and motion information of the robot to the robot.

However, according to the related art described above and the technologies introduced until now, only simple answering contents corresponding to conversation contents from the user are provided without the background knowledge of the user, and it fails to provide intimate and natural conversation based on various personal attributes (e.g., name, age, sex, glasses, beard, hobbies, and the like) about the user.

### DISCLOSURE

### Technical Problem

An object of the present invention is to solve all the problems of the related art described above.

In addition, another object of the present invention is to provide an intimate conversation service with a user based on at least one of a personal attribute related to the user and the reliability of the personal attribute.

In addition, still another object of the present invention is to provide an accurate and familiar conversation service based on continuously updated information about a user.

### Technical Solution

Representative configurations of the present invention for achieving the above objects are as follows.

According to an aspect of the present invention, there is provided a method of providing a conversation service using an autonomous behavior robot, which includes recognizing a user corresponding to acquired face information, determining a conversation content to be provided to the user based on at least one of a personal attribute related to the recognized user and a reliability of the personal attribute, and updating at least one of the personal attribute and the reliability of the personal attribute based on feedback of the user for the conversation content.

According to another aspect of the present invention, there is provided a system for providing a conversation service using an autonomous behavior robot, which includes a face information management unit configured to recognize a user corresponding to acquired face information, a conversation management unit configured to determine a conversation content to be provided to the user based on at least one of a personal attribute related to the recognized user and a reliability of the personal attribute, and an update management unit configured to update at least one of the personal attribute and the reliability of the personal attribute based on feedback of the user for the conversation content.

In addition, there are further provided another method, another system, and a non-transitory computer readable recording medium for recording a computer program for executing the method.

### Advantageous Effects

According to the present invention, it is possible to provide an intimate conversation service with a user based on at least one of a personal attribute related to the user and the reliability of the personal attribute.

According to the present invention, it is possible to provide an accurate and familiar conversation service based on continuously updated information about a user.

### DESCRIPTION OF DRAWINGS

FIG. 1 is a view illustrating an internal configuration of a system 100 for providing a conversation service according to an embodiment of the present invention in detail.

FIG. 2 is a view illustrating a situation in which a conversation service is provided according to an embodiment of the present invention.

FIG. 3 is a view illustrating a process of providing a conversation service according to an embodiment of the present invention.

FIG. 4 is a view illustrating a conversation template according to an embodiment of the present invention.

### DESCRIPTION OF REFERENCE NUMERAL

100: Conversation service providing system
110: Face information management unit
120: Conversation management unit
130: Update management unit
140: Communication unit
150: Control unit

### BEST MODE

### Mode for Invention

In the following detailed description, reference is made to the accompanying drawings that show, by way of illustration, specific embodiments in which the inventive concept may be practiced. These embodiments are described in sufficient detail to enable those skilled in the art to practice the inventive concept. It is to be understood that the various embodiments of the inventive concept, although different, are not necessarily mutually exclusive. For example, a particular feature, structure, or characteristic described herein in connection with one embodiment may be implemented within other embodiments without departing from the spirit and scope of the inventive concept. In addition, it is to be understood that the location or arrangement of individual elements within each disclosed embodiment may be modified without departing from the spirit and scope of the inventive concept. The following detailed description is, therefore, not to be taken in a limiting sense, and the scope of the inventive concept is defined only by the appended claims, appropriately interpreted, along with the full range of equivalents to which the claims are entitled. In the drawings, like numerals refer to the same or similar functionality throughout the several views.

Hereinafter, various embodiments of the present invention will be described in detail with reference to the accompanying drawings, so that those skilled in the art can easily carry out the present invention.

Configuration of System for Providing Conversation Service

Hereinafter, the internal configuration of the dialog service providing system 100 performing important functions for the implementation of the present invention and the functions of each component will be described.

FIG. 1 is a view illustrating an internal configuration of a system 100 for providing a conversation service according to an embodiment of the present invention in detail.

As shown in FIG. 1, the system 100 for providing a conversation service according to an embodiment of the present invention may include a face information management unit 110, a conversation management unit 120, an update management unit 130, a communication unit 140, and a control unit 150. According to an embodiment of the present invention, at least some of the face information management unit 110, the conversation management unit 120, the update management unit 130, the communication unit 140 and the control unit 150 may be program modules that communicate with an external system. Such a program module may be included in the system 100 for providing a conversation service in the form of an operating system, an application program module, or other program modules, and may be physically stored in various known storage devices. In addition, such a program module may be stored in a remote storage device that can communicate with the system 100 for providing a conversation service. Meanwhile, such a program module includes a routine, a subroutine, a program, an object, a component, a data structure, or the like that performs a particular task or executes a particular abstract data type that will be described below in accordance with the present invention, but is not limited thereto.

Meanwhile, the system 100 for providing a conversation service has been described above, but the description is exemplary. It will be apparent to those skilled in the art that at least some of the components or functions of the system 100 for providing a conversation service may be implemented or included in an external system (not shown) as necessary.

First, the face information management unit 110 according to an embodiment of the present invention may perform a function of recognizing a user corresponding to acquired face information.

For example, the face information management unit 110 according to an embodiment of the present invention may compare the face information acquired through a camera module (not shown) with a lookup table associated with face information of at least one user to recognize the user corresponding to the acquired face information.

Meanwhile, the face information management unit 110 according to an embodiment of the present disclosure may extract a main feature from an acquired object image and compare the main feature of the object image with object images of the lookup table (or database) for similarity, thereby using a face recognition algorithm, such as an algorithm for recognizing a specific object, and the like, well known in the art.

Next, the conversation management unit 120 according to an embodiment of the present invention may determine conversation contents to be provided to the user based on at least one of a personal attribute related to the user recognized by the face information management unit 110 and the reliability of the personal attribute. The personal attribute according to an embodiment of the present invention may include name, age, sex, appearance (whiskers, glasses, and the like), an emotional state, recent meeting date, recent conversation date, hobby, a favorite singer, marital status, and the like. In addition, according to an embodiment of the present invention, each of the personal attributes may include the reliability of how reliable the personal attribute is.

In detail, the conversation management unit 120 according to an embodiment of the present invention may determine a conversation type to be provided to the user based on at least one of the personal attribute of the user and the reliability of the personal attribute, and determine the conversation content associated with the determined conversation type as the conversation content to be provided to the corresponding user.

For example, the conversation management unit 120 according to an embodiment of the present disclosure may determine at least one of a conversation type for acquiring a personal attribute that has not been acquired yet, a conversation type for updating the and the reliability of a personal attribute, and a conversation type for attempting to have a friendly conversation by using the personal attribute having a certain level of reliability or more among the personal attributes, as the conversation type to be applied to the conversation with the corresponding user, based on at least one of the personal attribute of the user who is the counterpart of the conversation and the reliability of the personal attribute. In addition, the conversation management unit 120 according to an embodiment of the present invention may determine the conversation content associated with the conversation type determined above with reference to conversation templates grouped according to the personal attribute as the conversation content to be provided to the corresponding user. According to an embodiment of the present invention, the conversation template may be a database in which words, sentences, paragraphs, and the like for generating conversation contents are divided based on at least one of the personal attribute and the conversation type.

Meanwhile, according to an embodiment of the present invention, some of the personal attributes (e.g., an emotional state) may be set such that there is no reliability in the corresponding personal attribute or that the reliability of the personal attribute is always regarded as 100%.

In addition, the conversation management unit 120 according to an embodiment of the present invention may determine the conversation content to be provided to the user corresponding to an interest person among the recognized users.

For example, the conversation management unit 120 according to an embodiment of the present invention may calculate interest energy for the user based on at least one of a frequency, a number, and a period of time for acquiring face information, and determine the corresponding user as the interest person when the calculated interest energy is maintained above a predetermined level for a predetermined period of time.

In addition, the conversation management unit 120 according to an embodiment of the present invention may determine initial information of the personal attribute of the user by estimating the personal attribute of the user from the face information of the user.

For example, the conversation management unit 120 according to an embodiment of the present invention may estimate various information that may be acquired from the appearance of a face, such as age, sex, glasses, and beards, based on the face information of the user, thereby acquiring the initial information of the personal attribute of the user. Meanwhile, the conversation management unit 120 according to an embodiment of the present invention may set the reliability of the personal attribute estimated based on the face information of the user to a predetermined initial value (e.g., 50% of the reliability of 0 to 100% (that is, a middle value)).

Next, the update management unit 130 according to an embodiment of the present disclosure may update at least one of the personal attribute related to the user and the reliability of the personal attribute based on the user's feedback on the conversation content.

In detail, the update management unit 130 according to an embodiment of the present invention may update the reliability of the personal attribute of the user associated with the feedback based on the type of the feedback of the user related to the conversation content. According to an embodiment of the present invention, the type of the feedback may include at least one of positive, neutral and negative feedbacks.

For example, the update management unit 130 according to an embodiment of the present invention may change the reliability of the first personal attribute on the user downward when the user's feedback on the conversation content is a negative feedback for the first personal attribute on the user. When the user's feedback is a positive feedback for the first personal attribute, the update management unit 130 may change the reliability of the first personal attribute related to the user upward.

Meanwhile, in order to analyze the user's feedback for the conversation content, the update management unit 130 according to an embodiment of the present invention may use a known natural language processing technique such as morphological analysis, syntax analysis, semantic analysis, and the like.

In addition, according to an embodiment of the present invention, when the user's feedback for the conversation content includes the feedback for a plurality of personal attributes of the user, the update management unit 130 may refer to the feedback type for each personal attribute to update the reliability of the personal attribute.

For example, according to an embodiment of the present invention, in case where the conversation content provided to the user is “The clothes further emphasize the feminine beauty.” based on the person attributes for a user who are female and in her thirties, when the user feedbacks “I'm a man, and that's not suitable for me in my twenties.”, the update management unit 130 may change the reliability of each of the personal attributes of the female and 30's age to be lowered.

In addition, according to an embodiment of the present invention, as the reliability of the personal attribute regarding the user is updated, when the reliability of the personal attribute being updated is less than or equal to a predetermined level, the update management unit 130 may change the corresponding personal attribute itself.

For example, based on the user's feedback for the conversation content, when the reliability of the personal attribute whose sex is female is 50% or less, the update management unit 130 according to an embodiment of the present invention may change the personal attribute of sex from female to male.

Meanwhile, when the reliability of the personal attribute is equal to or less than a predetermined level and the personal attribute is changed, the update management unit 130 according to an embodiment of the present invention may allow the personal attribute of the changed personal attribute to be set (or initialized) to an initial value (e.g., 50%).

Meanwhile, when the personal attribute, which is not estimated from the face information of the user among the personal attributes of the user, is acquired through the feedback of the corresponding user, the update management unit 130 according to an embodiment of the present invention may set the initial value of the reliability of the personal attribute acquired from the user's feedback to be higher than that of the reliability of the personal attribute estimated from the face information of the user. That is, according to an embodiment of the present invention, since the personal attribute information acquired from the user's feedback occurring in the conversation is explicitly specified by the user, the personal attribute information obtained from the user's feedback rather than the personal attribute information estimated from the user's face information may be treated as more accurate information.

Next, the communication unit 140 according to an embodiment of the present invention may perform a function of enabling data transmission/reception from/to the face information management unit 110, the conversation management unit 120, and the update management unit 130.

Finally, the control unit 150 according to an embodiment of the present invention performs a function of controlling the data flow between the face information management unit 110, the conversation management unit 120, the update management unit 130, and the communication unit 140. That is, the control unit 150 according to the present invention may control the data flow from/to an outside of the system 100 for providing a conversation service or the data flow between components of the system 100 for providing a conversation service, thereby controlling the face information management unit 110, the conversation management unit 120, the update management unit 130, and the communication unit 140 to perform unique functions of them, respectively.

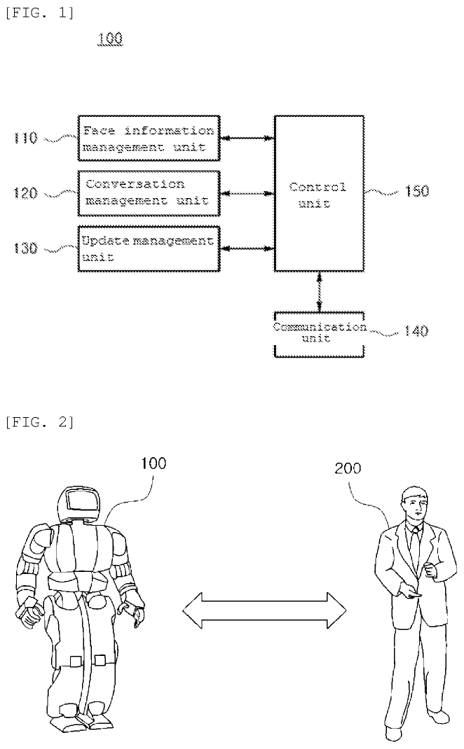

FIG. 2 is a view illustrating a situation in which a conversation service is provided according to an embodiment of the present invention.

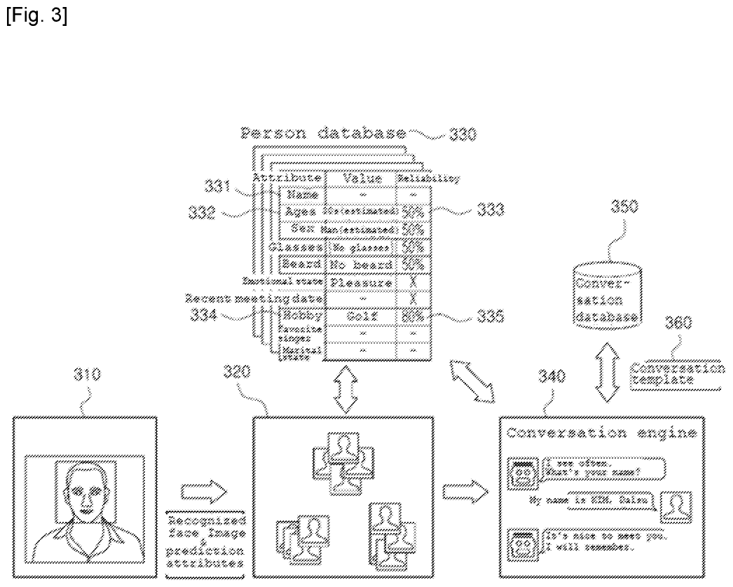

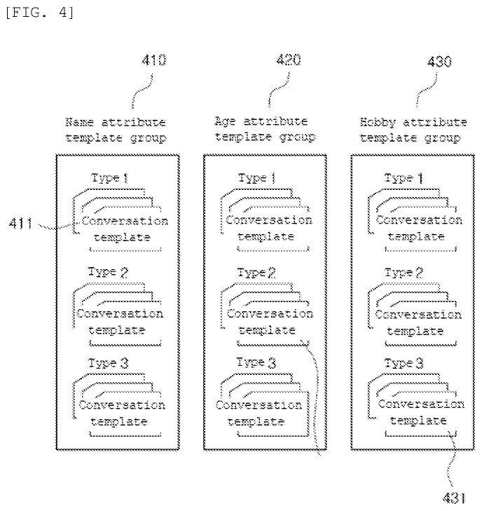

FIG. 3 is a view illustrating a process of providing a conversation service according to an embodiment of the present invention.

FIG. 4 is a view illustrating a conversation template according to an embodiment of the present invention.

Referring to FIGS. 2 to 4, it may be assumed that an autonomous behavior robot 300 including the system 100 for providing a conversation service according to an embodiment of the present invention provides a conversation service to a user 200.

First, according to an embodiment of the present invention, the autonomous behavior robot 300 may acquire the face information of the user 200 from the user 200.

Next, according to an embodiment of the present invention, in operation 310, the autonomous behavior robot 300 may recognize the user 200 corresponding to the acquired face information in operation 310. For example, the autonomous behavior robot 300 according to an embodiment of the present invention may acquire information about the user 200 corresponding to face information through a machine learning (or deep learning) algorithm such as a convolutional neural network (CNN) well known in the art, and recognize the user 200 with reference to the acquired information in operation 320. In addition, in operation 320, the autonomous behavior robot 300 according to an embodiment of the present invention may use a grouping technique such as a density based spatial clustering of application with noise (DBSCAN) algorithm well known in the art to specify the face of the user 200. Meanwhile, the autonomous behavior robot 300 according to an embodiment of the present invention may include a database (not shown) for storing, managing or learning face information which is the face information first recognized and acquired as described above or face information which is not specified.

Meanwhile, the autonomous behavior robot 300 according to an embodiment of the present invention, by estimating the personal attribute of the user 200 from the face information of the user 200, the initial information of the personal attribute of the user 200 It may be acquired in operation 330.

Next, when the recognized user 200 is determined as an interest person in operation 320, the autonomous behavior robot 300 according to an embodiment of the present invention may determine a conversation content to be provided to the user 200 based on at least one of the personal attribute o the user 200 and the reliability of the personal attribute.

For example, the autonomous behavior robot 300 according to an embodiment of the present invention may determine, as the conversation type to be provided to the user 200, the conversation type (e.g., type 1) required to obtain the personal attribute of the name 331, which has not yet been acquired among various personal attributes for the corresponding user, and extract the conversation content to be provided to the corresponding user 200 from the conversation type 411 (that is, type 1) previously determined among several conversation templets 360 grouped according to the personal attribute or the conversation type and the target conversation templet corresponding to the personal attribute 410 (that is, the name) of the corresponding user, or generate the conversation content to be provided to the corresponding user 200 based on the target conversation template. In this case, in operation 340, the autonomous behavior robot 300 according to an embodiment of the present invention may provide the corresponding user 200 with the conversation content of “I see often. What is your name?”.

As another example, the autonomous behavior robot 300 according to an embodiment of the present invention may determine, as the conversation type to be provided to the corresponding user 200, the conversation type (e.g., type 2) required to update the reliability of the personal attribute of the age 332 among several personal attributes for the corresponding user 200, and extract the conversation content to be provided to the corresponding user 200 from the conversation type 421 (that is, type 2) previously determined among several conversation templets 360 grouped according to the personal attribute or the conversation type and the target conversation templet corresponding to the personal attribute 420 (that is, the age) of the corresponding user, or generate the conversation content to be provided to the corresponding user 200 based on the target conversation template in operation 340. In this case, the autonomous behavior robot 300 according to an embodiment of the present invention may provide the user 200 with the conversation content of “thirty needs perfect skin care.” in operation 340.

As still another example, the autonomous behavior robot 300 according to an embodiment of the present invention may determine, as the conversation type to be provided to the corresponding user 200, a conversation type (e.g., a type 3) that attempts a familiar conversation based on a person attribute of a hobby 334 of which the reliability 335 is equal to or higher having a certain level, among various person attributes of the corresponding user 200, and extract the conversation content to be provided to the corresponding user 200 from the conversation type 431 (that is, type 3) previously determined among several conversation templets 360 grouped according to the personal attribute or the conversation type and the target conversation templet corresponding to the personal attribute 430 (that is, a hobby) of the corresponding user, or generate the conversation content to be provided to the corresponding user 200 based on the target conversation template in operation 340. In this case, the autonomous behavior robot 300 according to an embodiment of the present invention may provide the user 200 with a dialogue content that “Kim 00 is the best golf player.” in operation 340.

Meanwhile, the autonomous behavior robot 300 according to an embodiment of the present invention may determine, as the conversation content to be provided to the user, only the conversation type (that is, type 3) that attempts a familiar conversation based on a person attribute among the conversation types for the personal attribute which has a predetermined level of reliability or more among several personal attributes. That is, the personal attribute having a predetermined level of reliability or more is treated as accurate information and is no longer changed.

Meanwhile, the autonomous behavior robot 300 according to an embodiment of the present invention may further refer to a conversation database 350 previously constructed with respect to the conversation contents associated with the conversation type.

Next, the autonomous behavior robot 300 according to an embodiment of the present invention may update at least one of the personal attribute and the reliability of the personal attribute based on the feedback of the user 200 with respect to the conversation content provided above.

For example, the autonomous behavior robot 300 according to an embodiment of the present invention nay acquire the personal attribute of name 331 among the personal attributes from the feedback when the feedback of the corresponding user 200 with respect to the conversation content of “I see often. What is your name?” provided thereto is “I am KIM OO.”, and may set, as the initial value, the reliability of the personal attribute of the name 331 to 75% which is higher 50% which is the initial value of the reliability of another personal attribute obtained from the face information.

As another example, when the feedback of the corresponding user 200 to the conversation content of “thirty needs perfect skin care” is a negative feedback such as “I am not in thirty”, the autonomous behavior robot 300 according to an embodiment of the present invention may adjust the reliability of the personal attribute of age 332 among the personal attributes to be lower than 50% 333.

As still another example, when the feedback of the corresponding user 200 to the conversation content of “KIM 00 is the best golf player” is “yes” or “I think so”, the autonomous behavior robot 300 according to an embodiment of the present invention may maintain the reliability of the personal attribute of a hobby 334 among the personal attributes without modification because the corresponding conversation type is a conversation type for attempting to have a friendly conversation with the corresponding user 200, and there is no negative feedback of the user 200.

Meanwhile, according to an embodiment of the present invention, the conversation template 360 may include trigger information for analyzing the feedback of the corresponding user 200. The trigger information according to an embodiment of the present invention may include information about at least one of a recognition trigger for obtaining a personal attribute, a positive trigger for a personal attribute, a negative trigger for a personal attribute, and a progress trigger for continuing a conversation.

For example, a conversation template that corresponds to a conversation type (that is, type 1 above) required to obtain a personal attribute which is not yet acquired among the several conversation templates 360 may include information about a trigger for recognizing the corresponding personal attribute from the feedback of the corresponding user 200. In more detail, when the conversation content associated with the conversation type is “I see often. What is your name?” and the feedback of the user 200 is “My name is Kim OO”, the part corresponding to “Kim OO” may be a recognition trigger for obtaining a personal attribute.

As another example, the conversation template that corresponds to a conversation type (that is, type 2 above) required to update the reliability of a personal attribute among several conversation templates 360 may include information about a positive or negative trigger for a personal attribute. In more detail, when the conversation content associated with the corresponding conversation type is “You're a really cool guy.” and the feedback of the corresponding user 200 is “I'm a woman?” or “I'm a woman.”, the part corresponding to “woman” may be a trigger for recognizing negation of a personal attribute.

As still another example, a conversation template that corresponds to a conversation type (that is, type 3 above) for attempting to have a friendly conversation based on the personal attribute having a predetermined level of reliability among several conversation templates 360 may include a progress trigger for continuing a conversation. In more detail, when the conversation content associated with the corresponding conversation type is “IU's really the best singer.” and the feedback of the corresponding user 200 is “Right” or “I think so too”, the part corresponding to “Right” or “I think so too” may be a progress trigger for continuing a conversation.

The embodiments according to the present invention described above may be implemented with program instructions which may be executed through various computer means and may be recorded in computer-readable media. The media may also include, alone or in combination with the program instructions, data files, data structures, and the like. The program instructions recorded in the media may be designed and configured specially for the embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described embodiments of the inventive concept, or vice versa.

While the present invention has been particularly shown and described with reference to embodiments thereof, it is to be understood that the invention is not limited to the disclosed embodiments, but, on the contrary, Those skilled in the art will appreciate that various modifications and changes may be made thereto without departing from the scope of the present invention.

Accordingly, the spirit of the present invention should not be construed as being limited to the above-described embodiments, and all ranges equivalent to or equivalent to the claims of the present invention, as well as the claims of the following claims.

1. A method of providing a conversation service using an autonomous behavior robot, the method comprising:
recognizing a user corresponding to acquired face information;
determining a conversation content to be provided to the user based on at least one of a personal attribute related to the recognized user and a reliability of the personal attribute; and
updating at least one of the personal attribute and the reliability of the personal attribute based on feedback of the user for the conversation content.

2. The method of claim 1, wherein the determining further comprises determining whether the recognized user corresponds to an interest person, and
wherein the interest person includes a user whose interest energy, which is determined by referring to at least one of a frequency, a number, and a period of time for acquiring face information, is maintained for a predetermined period of time or more.

3. The method of claim 1, wherein the determining further includes:
determining a conversation type to be provided to the user based on the personal attribute and the reliability of the personal attribute; and
determining a conversation content associated with the conversation type by referring to a conversation template grouped according to the personal attribute.

4. The method of claim 1, wherein the updating includes updating the reliability of the personal attribute of the user associated with the feedback by referring to a type of the feedback.

5. The method of claim 1, wherein the updating includes changing the personal attribute when the reliability of the updated personal attribute has a predetermined level or less.

6. The method of claim 5, further comprising resetting the updated reliability of the personal attribute when the personal attribute is changed.

7. The method of claim 1, wherein initial information of the personal attribute is estimated from face information of the user or acquired from the feedback of the user.

8. The method of claim 7, wherein an initial value of the reliability of the personal attribute acquired from the feedback of the user is set higher than an initial value of the reliability of the personal attribute estimated from the face information of the user.

9. A non-transitory computer readable recording medium that stores a computer program for executing the method according to claim 1.

10. A system for providing a conversation service using an autonomous behavior robot, the system comprising:
a face information management unit configured to recognize a user corresponding to acquired face information;
a conversation management unit configured to determine a conversation content to be provided to the user based on at least one of a personal attribute related to the recognized user and a reliability of the personal attribute; and
an update management unit configured to update at least one of the personal attribute and the reliability of the personal attribute based on feedback of the user for the conversation content.
